(19) United States
(12) Patent Application Publication
(10) Pub. No.: US 2023/0374852 A1
(43) Pub. Date: Nov. 23, 2023

(54) MODULAR STORM SHELTER

(71) Applicant: WSVK OEDERAN GMBH, Oederan (DE)

(72) Inventor: Marcus SCHMIEDECK, Oederan (DE)

(73) Assignee: WSVK OEDERAN GMBH, Oederan (DE)

(21) Appl. No.: 18/248,348

(22) PCT Filed: Oct. 15, 2021
(86) PCT No.: PCT/EP2021/078689

§ 371 Date: Apr. 7, 2023

(30) Foreign Application Priority Data
Oct. 16, 2020 (DE) 10 2020 127 347.9

(51) Int. Cl. E06B 9/02

(52) U.S. Cl. CPC E06B 9/02; E06B 2009/005

(57) ABSTRACT

The invention relates to a device for protecting building façades and/or building openings, thus for protecting windows and/or doors or the like, from storm conditions. A flat cover is provided comprising peripheral narrow surfaces with a peripheral frame element in the form of a profiled section.

The frame element is arranged in a peripheral manner about the flat cover along the narrow surfaces thereof. The arrangement about the flat cover along the narrow surfaces is carried out in segments or sub-elements. The individual sub-elements are fixed against one another and/or to one another by a wide variety of securing means which are not specified in greater detail. In the process, at least one of the sub-elements and/or the flat cover has devices for securing on or against another surface. The device is thus suitable for installing on building façades and/or in front of building openings.

The invention relates to a device for protecting building façades and/or building openings.

In the course of climate change, severe weather events such as heavy rain, hurricanes and/or floods are expected to occur with increasing frequency. If such phenomena occur, dangerous accompanying phenomena such as wind-borne, projectile-like objects or even the explosions of hazardous goods are always possible.

In order to protect interiors of buildings, and thus also the people inside them, from such influences and accompanying phenomena, the following solutions are known from the prior art, for example.

The subject matter in US 2007/0227084 A1 is a building window shutter and/or building door shutter for protection against wind and wind-borne foreign objects. This protection consists of a non-rigid panel made of coated water-tight polyester, a rigid polycarbonate panel and a second panel of non-rigid material made of a high-tensile polyester fiber mesh, which are all mounted in layers and are connected by rigid rails to a building structure adjoining the window and doors. When the window shutters are not in use, the non-rigid panels can be rolled up or folded and stored.

U.S. Pat. No. 6,209,263 B1 describes a hurricane window shutter system for quick and easy installation of hurricane window shutters without the use of a ladder. The hurricane window shutter system comprises an upper mounting sleeve, which can be screw-fastened to a building, mounting brackets for connecting to the upper mounting sleeve and a cover panel assembly which can be inserted into the mounting sleeve and screw-fastened to the mounting bracket, wherein the cover panel assembly is connected to the building to cover a window of the building.

US 2006/0070305 A1 describes pneumatic hurricane shutters for building window openings. These shutters are intended to temporarily cover a window or door in a building or other structure. The window shutters have a lightweight rigid frame surrounding the openings and mounted on securing elements attached to the building. Elongate pneumatic tubes are connected to frame rails and span the space between the rails to protect the opening. The frames can be locked in place to prevent accidental removal once in place. The frames and deflated tubes can be stored until the approach of a storm. At this time the frames may be secured to the building and the tubes inflated to protect the openings.

U.S. Pat. No. 6,779,582 B2 describes a hurricane window shutter system with accordion folding window shutters based on the mathematical relationship between the deployed length of the window shutter, the stacked or folded length of the window shutter and the size of an opening in a structure. The relationship results in a shutter system that has different sized openings with the least number of shutter assemblies and without excess assemblies.

EP 3 243 994 A1 discloses a system for mounting a secondary panel within a window frame of an existing window. The described system comprises a rigid panel, an elongate and deformable bulb, and an elongate carrier. The bulb has a resilient portion, a base portion, an extension extending from the base portion, and a crosspiece coupled to a distal end of the extension. The crosspiece comprises a pair of shoulders at opposite ends of the crosspiece. Each shoulder protrudes laterally beyond the extension. The elongate carrier is designed to receive an edge of the secondary panel. The receiving device is a slot which is configured to securely receive the cross beam of the piston and to confine the shoulders of the crosspiece.

DE 9 411 800 U1 discloses a device for covering a wall opening for a window or a door against flooding, which opening is delimited by a wall soffit. The device is characterized by a tightly filled-in projection frame having an endless hose seal provided on its outer edge. The hose seal is in this case designed to be watertight and inflatable and is designed to be variable in volume at least outside the projection frame.

US 2013/0019742 A1 describes an explosion-protected unit for explosion protection. This unit comprises: a protective panel, a sub-frame around the protective panel and a plurality of energy absorption units. The energy absorption units are provided to connect the sub-frame to the protective panel. Each of the energy absorption units can be connected to the protective panel and the sub-frame, such that the explosion-protected unit is formed. The energy absorption units are provided to deform under an explosion force applied against the side of the protective panel, allowing the protective panel to move away from the sub-frame. The explosion-protected unit may be connected to a building structure such that the internal portion of the building structure is protected against blast effects.

The systems in the prior art are difficult to assemble and require a high degree of planning and manufacturing outlay. Despite this, it is not possible to form arbitrary geometries. For example, large and flat glass façades cannot be produced using conventional systems. Often, bulky receiving devices for securing the protective devices may be considered, which additionally increase the installation effort and create an obstacle in order to repair or replace damaged protective devices. Furthermore, the present protective systems have only a low light transmission, which is extremely disadvantageous in the event of a power failure during a storm.

The object of the invention is to overcome the disadvantages of the prior art and to provide an individual storm shelter device.

The object is achieved by the features of the main claim and by the features of the independent claims. Preferred embodiments are the subject matter of the dependent claims in each case.

A first aspect of the invention relates to a device for protecting building façades and/or building openings from storm conditions and/or explosions, wherein a segmented frame element in the form of a profiled section is formed about a flat cover with peripheral narrow surfaces. Within the meaning of the invention, a frame element is formed from at least two sub-elements. According to the invention, the frame element or the sub-elements forming the frame element are manufactured at least in part from resilient material. According to the invention, the frame element or the sub-elements thereof is arranged in a peripheral manner about the flat cover on narrow surfaces of the flat cover, and the arrangement about the panel-shaped cover along the narrow surfaces is carried out.

Within the meaning of the invention, the individual sub-elements are mutually fixed against one another and/or to one another by a wide variety of securing means. With its sub-elements, the frame element thus encloses the flat cover along the narrow surfaces. To form the frame element, the individual sub-elements are designed to be mutually secured against one another and/or to one another by a wide variety of securing means. According to the invention, at least one of the sub-elements and/or the flat cover has devices for securing on or against another surface. Within the meaning of the invention, the device comprising a frame element and a flat cover is thereby designed for installing in front of building façades and/or building openings.

In the following and substantially, storm conditions are understood as weather events that are capable of causing direct and indirect damage to their surroundings. This includes, but is not limited to, hurricanes, hailstorms, and heavy rain events. Furthermore, the objects that are carried by these same storms are also included. Additionally, flooding or high-water events are also counted as storm conditions.

In the following, in addition to planar surfaces, a flat cover also comprises curved surfaces which form the surfaces of volume bodies or segments of the surface of volume bodies. In this case, volume bodies are, for example—without being limited thereto—spheres, cylinders, cones, polyhedra and combinations thereof.

In relation to the material of the flat cover, the resilient material according to the invention is at least 20% more resilient, preferably at least 40%, even more preferably at least 60% and most preferably at least 80% more resilient than the material of the flat cover. The resilience is understood as a measure of the compression that a material cube having an edge length of 1 cm experiences when placed flat when it is subjected to a falling weight of 1 kg and a contact surface in parallel with the cube surface from a fall height of 10 cm.

The frame element is arranged about these flat covers; at least one frame element and at least one flat cover form a protective element.

In preferred embodiments of the invention, at least one sub-element of the peripheral frame element in the form of a profiled section is formed in part from a resilient material and from a reinforcing material. Thus, the stiffness and strength of the frame elements can be advantageously adapted to the particular environment in which the storm shelter is to be used. For example, but not limited to, in areas with frequent heavy rainfall events, a high degree of resilient material is used in order to achieve as flat a connection as possible between frame elements and the building façade to which the protective element is to be attached.

In preferred embodiments of the invention, the panel-shaped or flat cover is formed from a material which has a higher hardness than the expanded plastics material.

For the evaluation and comparison of the hardnesses of the flat cover and the frame element or its sub-elements, respectively, one and the same method for determining hardness is to be used for both objects of comparison.

This is advantageous, since in this way, for example, the kinetic energy of wind-borne objects colliding with this cover is not fully performed as deformation work on the flat cover. Rather, part of the energy is invested in the elastic deformation of the frame element when the force impact is transmitted. Thus, with a lower outlay in terms of material, higher proficiencies can be achieved in the event of impacts compared to a comparable rigid embodiment.

Such panels include, but are not limited to, composite panels made of polycarbonates and other plastics materials, sandwich panels, or honeycomb composite panels.

In preferred embodiments of the invention, at least one surface facing away from the panel-shaped cover has devices for direct mutual mounting and/or mutual securing. In this context, surfaces that are not covered by the narrow surfaces of the bottle-shaped cover count as facing away.

For example, without being limited thereto, a portion on the surface of a sub-element of the frame element has the groove of a dovetail guide, wherein another sub-element has the corresponding mating tongue of a dovetail guide. Thus, these elements are formed so as to be directly fixable to one another by sliding them into one another. This is advantageous since, in this way, various sub-elements with a different groove/tongue arrangements can be attached to a flat cover and thus a combination of a plurality of protective elements can be produced.

In preferred embodiments of the invention, at least one surface facing away from the panel-shaped cover has devices for indirect mutual mounting and/or securing. For example, without being limited thereto, a portion on the surface of all the sub-elements of the frame element has the groove of a dovetail guide. In this case, the groove is formed to be in alignment such that when the sub-elements are connected to the frame element a continuous groove of the dovetail guide is formed. A separate tongue element corresponding to the tongue of a dovetail guide as two mirrored cross-sections can now be introduced into this groove. This tongue element is thus a device for the indirect securing of sub-elements. This is advantageous since the manufacturing outlay and the installation outlay are thus reduced. Thus, individual protective elements can be combined into a larger protective element by using the tongue elements.

In embodiments of the invention, the device has elements for indirectly and/or directly connecting frame elements. Thus, predetermined breaking points can advantageously be introduced into the frame elements of the protective elements in order to achieve further possibilities for energy absorption of the protective elements. This is necessary, for example, due to a parallel arrangement of individual protective elements, which are also sufficient for the combination of larger protective elements. Advantageously, in this way it is possible to respond individually to the need for protection of the respective building portions and to adapt the respective protective elements.

In preferred embodiments of the invention, at least one portion of the peripheral frame element in the form of a profiled section has a sealing element which is designed for watertight sealing between at least two frame elements. In this way, watertight protective elements can be manufactured, which are formed from at least two individual protective elements. This is advantageous since in this way drainage channels for incoming rainwater can be formed by linking a plurality of frame elements or the sub-elements thereof. This in turn has a positive effect on the diversity in the scope of application and the storm events to be averted.

In preferred embodiments of the invention, at least one portion of the peripheral frame element in the form of a profiled section has a sealing element which is formed for watertight sealing between at least one frame element and a building wall.

For example, but not limited thereto, this sealing element is made of a resilient material which in cross-section is implemented as a tongue of a dovetail guide. This embodiment is introduced into the groove of the frame elements and is thus connected to the protective element in a form-fitting manner. By means of the securing means between the building wall and the frame element, the resilient material protruding from the frame element is pressed against the building wall. Due to the applied pressure, the resilient material conforms against the building wall.

In embodiments of the invention, the plastics material of the frame element or the sub-elements is selected, wherein the plastics material is preferably selected from polystyrene, polyethylene, polyurethane and/or polypropylene and or from mixtures thereof.

In embodiments of the invention, the composite material of the frame element or the sub-elements is selected from mixtures of various materials. For example, without being limited thereto, a combination of natural fibers with a suitably high proportion of a rubber mixture for achieving the desired resilience is just as conceivable as a metal frame to which the resilient material is superimposed by means of an adhesive in order to achieve the resilience according to the invention.

In preferred embodiments of the invention, the flat cover is selected from sandwich panels, hollow core panels, metal foam panels and/or honeycomb composite panels, wherein the preferred materials of the flat cover are selected from composites, fiberglass, carbon fiber, natural fiber, aluminum foam, fiber-reinforced plastics material and/or mixtures thereof.

In preferred embodiments of the invention, the selected material of the flat cover is translucent. This is advantageous because it ensures a minimum level of interior lighting, at least during the day, even in the event of a storm-related power outage, while maintaining the protective effect against storm conditions.

In preferred embodiments of the invention, the device is used to protect building façades and/or building openings, in particular windows and/or doors, from storm conditions and/or explosions, in particular from storms, from storm-borne objects and/or from floods as well as flotsam thereof. In addition, the device is used as protection of building façades and/or building openings, in particular windows and/or doors, against explosion pressure waves.

In order to realize the invention, it is also expedient to combine the above-described embodiments and the features of the claims.

The invention is explained in more detail below with reference to a number of exemplary embodiments and associated figures. The exemplary embodiments are intended to describe the invention without limiting it.

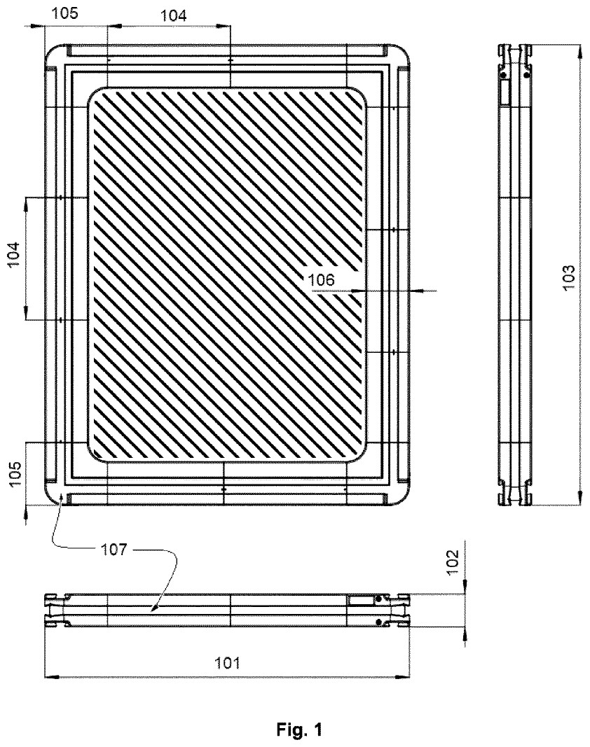

FIG. 1 schematically shows the principle of various views of a fully assembled protective element. The flat cover is enclosed by 90° corner elements and linear elements. The flat cover is shown hatched in this case. In this example, the leg sides of the corner element (105) are identical in the direction of the overall height of the protective element (103) and in the direction of the width of the protective element (101).

It should be noted that any edge length can be wrapped by cutting the respective lengths of the sub-elements (104).

In one embodiment, a protective element for a façade opening of a width of 1 m and a height of 1.2 m is configured as follows. A planar and rectangular cover in the form of a sandwich panel made of fiberglass-reinforced polypropylene with dimensions of 1090 mm wide, 1446 mm high and 25 mm thick is enclosed circumferentially by a frame consisting of 14 sub-elements. Each sub-element is made of expanded polypropylene. In addition to the 4 sub-elements which enclose the 90° corners of the rectangle, 10 sub-elements are used in a linear embodiment. One element of each of the 4 corner elements has a leg length of 230 mm and one element of each of the 6 linear elements has a production length of 450 mm. Furthermore, 2 each of the linear elements are cut to a length dimension of 332 mm in order to achieve the correct height and two each of the linear elements are cut to a length dimension of 426 mm in order to achieve the correct width.

In the assembled state, the protective element has a total width of 1336 mm and a total height of 1692 mm. The maximum thickness of the protective element is 120 mm. Embedded into the lateral walls of each sub-element are recesses that achieve the groove of a dovetail profile. In the assembled state, the possibility for building securing is thus provided along the lengths and widths of the protective element by a corresponding counterpart—formed as a tongue of a dovetail profile. The connection of the sub-elements to one another is achieved by pins which are inserted into bores which can be seen in cross-section of the profiles.

### REFERENCE SIGNS

101 Total width of a protective element
102 Total thickness of a protective element
103 Total height of a protective element
104 Length of a sub-element
105 Leg length of a 90° corner element
106 Width of a sub-element
107 Recess as groove for securing means

1. A device for protecting building façades and/or building openings, wherein a peripheral frame element in the form of a profiled section is formed about a flat cover comprising peripheral narrow surfaces, wherein the frame element is formed at least in part from resilient material and is arranged in a peripheral manner about the flat cover on the narrow surfaces thereof, and the arrangement about the panel-shaped cover along the narrow surfaces is carried out, wherein the peripheral frame element is formed from at least two sub-elements, wherein the individual sub-elements are each fixed against one another and/or to one another by a wide variety of securing means, wherein at least one of the sub-elements and/or the flat cover has devices for securing on or against another surface and thus the device is designed for installing in front of building façades and/or building openings,
wherein
the surfaces of the sub-elements facing away from the panel-shaped cover have devices for indirect mutual mounting and/or securing.

2. The device according to claim 1, wherein at least one portion of the peripheral frame element in the form of a profiled section is formed at least in part from a resilient material and from a reinforcing material.

3. The device according to claim 2, wherein the panel-shaped or flat cover is formed from a material having a lower resilience than the resilient parts of the frame elements.

4. The device according to claim 1, wherein the surfaces of the portions facing away from the panel-shaped cover have devices for direct mutual mounting and/or securing.

5. The device according to claim 1, wherein at least one portion of the peripheral frame element in the form of a profiled section has a sealing element which is formed for watertight sealing between at least two frame elements.

6. The device according to claim 1, wherein at least one portion of the peripheral frame element in the form of a profiled section has a sealing element which is designed for watertight sealing between at least one frame element and a building wall.

7. The device according to claim 1, wherein the resilient material is selected from plastics materials and composite materials.

8. The device according to claim 1, wherein the flat cover is selected from sandwich panels, hollow core panels, metal foam panels and/or honeycomb composite panels.

9. The device according to claim 1, wherein the flat cover is translucent.

10. A method for protecting building façades and/or building openings from storm conditions and/or explosions, said method comprising installing the device according to claim 1.

11. The device according to claim 2, wherein the surfaces of the portions facing away from the panel-shaped cover have devices for direct mutual mounting and/or securing.

12. The device according to claim 3, wherein the surfaces of the portions facing away from the panel-shaped cover have devices for direct mutual mounting and/or securing.

13. The device according to claim 3, wherein at least one portion of the peripheral frame element in the form of a profiled section has a sealing element which is formed for watertight sealing between at least two frame elements.

14. The device according to claim 12, wherein at least one portion of the peripheral frame element in the form of a profiled section has a sealing element which is formed for watertight sealing between at least two frame elements.

15. The device according to claim 3, wherein at least one portion of the peripheral frame element in the form of a profiled section has a sealing element which is designed for watertight sealing between at least one frame element and a building wall.

16. The device according to claim 14, wherein at least one portion of the peripheral frame element in the form of a profiled section has a sealing element which is designed for watertight sealing between at least one frame element and a building wall.

17. The device according to claim 3, wherein the resilient material is selected from plastics materials and composite materials.

18. The device according to claim 3, wherein the flat cover is selected from sandwich panels, hollow core panels, metal foam panels and/or honeycomb composite panels.

19. The device according to claim 3, wherein the flat cover is translucent.

20. The device according to claim 16, wherein:
the resilient material is selected from plastics materials and composite materials;
the flat cover is selected from sandwich panels, hollow core panels, metal foam panels and/or honeycomb composite panels; and
the flat cover is translucent.
